(19) United States
(12) Patent Application Publication
(10) Pub. No.: US 2010/0051528 A1
(43) Pub. Date: Mar. 4, 2010

(54) Seal Improvement for Lube Filter

(75) Inventors: Ian Joseph Derstler, Columbia, PA (US); Richard Kurcina, Lancaster, PA (US)

Correspondence Address: REINHART BOERNER VAN DEUREN P.C., 2215 PERRYGREEN WAY, ROCKFORD, IL, 61107, US

(73) Assignee: Clark Filter, Inc., Lancaster, PA (US)

(21) Appl. No.: 12/198,348

(22) Filed: Aug. 26, 2008

(51) Int. Cl. B01D 63/06; B01D 35/30; B01D 27/00

(52) U.S. Cl. 210/232; 210/442; 210/321.89

(57) ABSTRACT

A filter for applications such as a lube filter for a large medium speed diesel engine application lube system is provided in which the open end cap carries three different seals including two radial seals that seal radially against a stem pipe in an axial abutment face and a seal gasket that seals against a mounting face of the housing. One of the radial seals is more reliable than the other while the other of the radial seals acts as a redundant backup and safety in the event that there is an improper installation or damage to the other seal as a result thereof.

### FIELD OF THE INVENTION

The present invention generally relates to filter cartridges and more particularly relates to the sealing mechanisms carried by end caps of such filter cartridges for sealing against a housing or other fluid port for communication with a fluid system.

### BACKGROUND OF THE INVENTION

Filter cartridges are used for a wide variety of different applications for filtering such fluids as air, liquids, fuels, and oils. An example of one filtration application is lube filters for large medium speed diesel engine applications. For example, illustrations of a prior art filter for a lube filter for large medium speed diesel engine applications are shown in FIGS. 1 and 2. FIG. 1 shows a perspective view of the overall cartridge and FIG. 2 shows a close-up view of two seals carried on the upper end cap (given the orientation in the figures). This configuration includes a flat annular gasket for radially sealing against a housing stem point; and secondarily, an outer face seal gasket that includes an axial abutment sealing surface projecting axially from the end cap that can axially abut and seal against a flat face of the housing. The end cap includes a retainer that retains both seals serving their separate functions in place.

The present invention is directed towards improvements over this type of a sealing design and which may be employed in a railroad lube filtration application and/or other filtration applications as may be appropriate.

### BRIEF SUMMARY OF THE INVENTION

The present invention pertains to using two different gaskets which bound the central opening of the end cap for sealing the fluid port extending through the end cap, preferably by both radially sealing against the housing stem pipe.

One aspect is directed toward a filter cartridge comprising a tubular ring of filter media having opposed first and second ends. A first end cap is sealingly bonded to the first end and a second end cap is sealingly bonded to the second end. The second end cap includes a central opening providing a fluid port communicating internally with the tubular ring of filter media. A first gasket bounds the central opening for sealing a fluid port. Additionally, a second gasket also bounds the central opening for sealing the fluid port.

In regards to the above aspect, preferably the first and second gaskets are carried by the second end cap. A third gasket, is also carried by the second end cap, and is disposed in surrounding relation of the first and second gaskets. The first and second gaskets may be radial seals including different forms of radial seals such as an O-ring gasket and a flat gasket that seal differently (one via compression and the other via deflection, acting as a wiper seal). The flat gasket can act as a redundant backup to the more reliable O-ring gasket in the event of damage to the O-ring gasket, that may be an issue due to the potential for blind insertion of these types of filter elements according to preferred embodiments, such as in the railroad lube filtration applications.

Yet another subsidiary aspect may be directed towards the retainer structures of such seals in which the second end cap may include a metal and disc member that is sealingly bonded to the media (such as with plastisol or other adhesive); an outer metal retainer and an inner metal retainer. The inner retainer retains the first gasket inside of the metal end disc member while the metal outer retainer retains the second gasket outside of the metal end disc member.

Another aspect of the present invention is directed towards a filter assembly comprising in combination a filter cartridge such as may be defined above in combination with a housing that has a flat mounting face and an outer wall projecting axially therefrom greater than two feet. A plurality of stem pipes project from the mounting face in spaced apart relation in which each stem pipe has a tapered end tip. Multiple filter cartridges such as ones as defined above may be mounted onto the stem pipes in fluid parallel with one another.

For such an application, another different gasket provides means for sealing against the stem pipe in redundancy to the first means and another gasket provides means for axially sealing against the flat mounting face.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective view of a filter according to a prior art example;

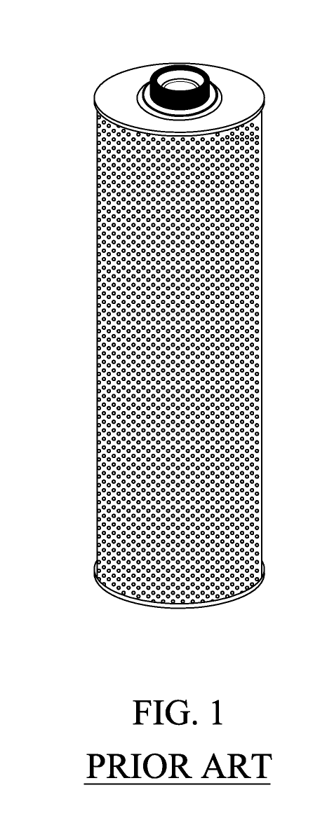

FIG. 2 is a cross-sectional view of one of the end caps of the filter cartridge shown in FIG. 1 along with the two seals carried thereby;

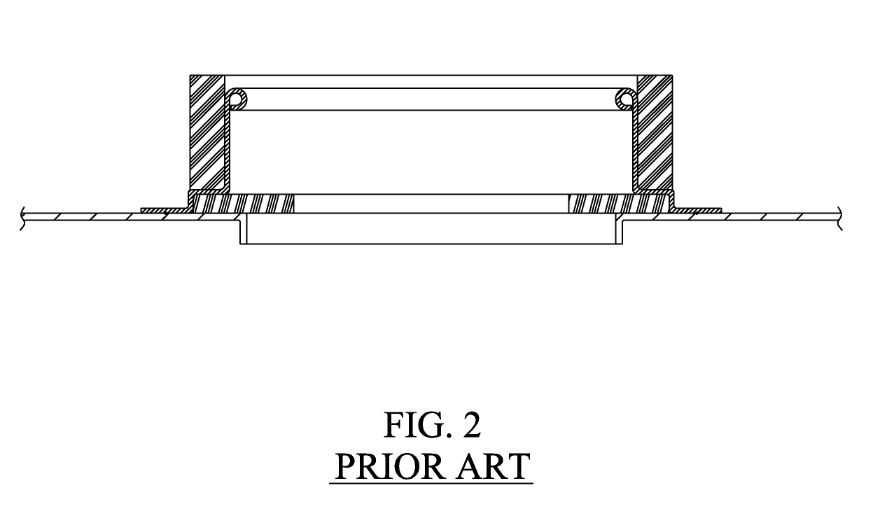

FIG. 3 is a perspective view of a filter cartridge in accordance with an embodiment of the present invention;

FIG. 4 is a cross-sectional view of one of the end caps of the filter cartridge shown in FIG. 1 along with the three gaskets carried thereby; and

FIG. 5 is a partly schematic cross-sectional view of a filter assembly including a bank of filter cartridges such as those shown in FIGS. 3 and 4 as mounted in combination with a filter housing including a plurality of stem pipes extending from a flat mounting face thereof.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

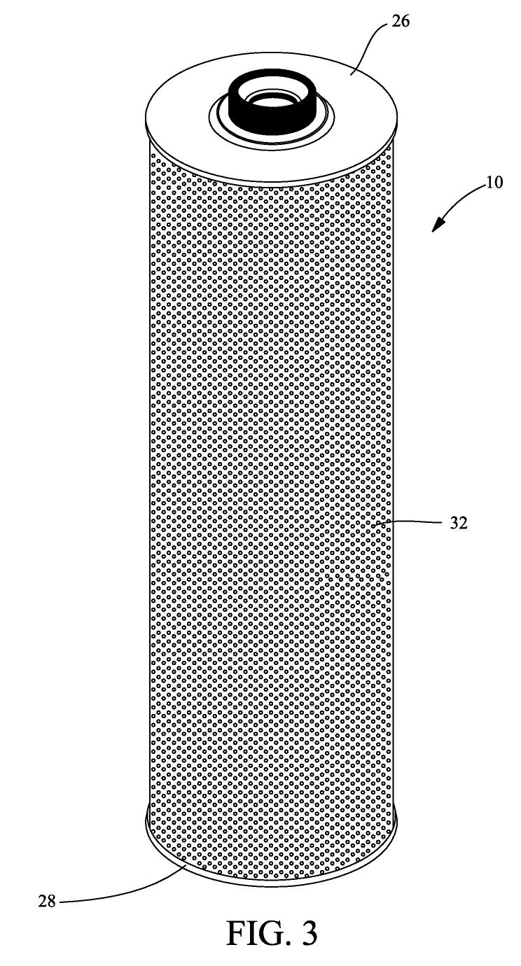

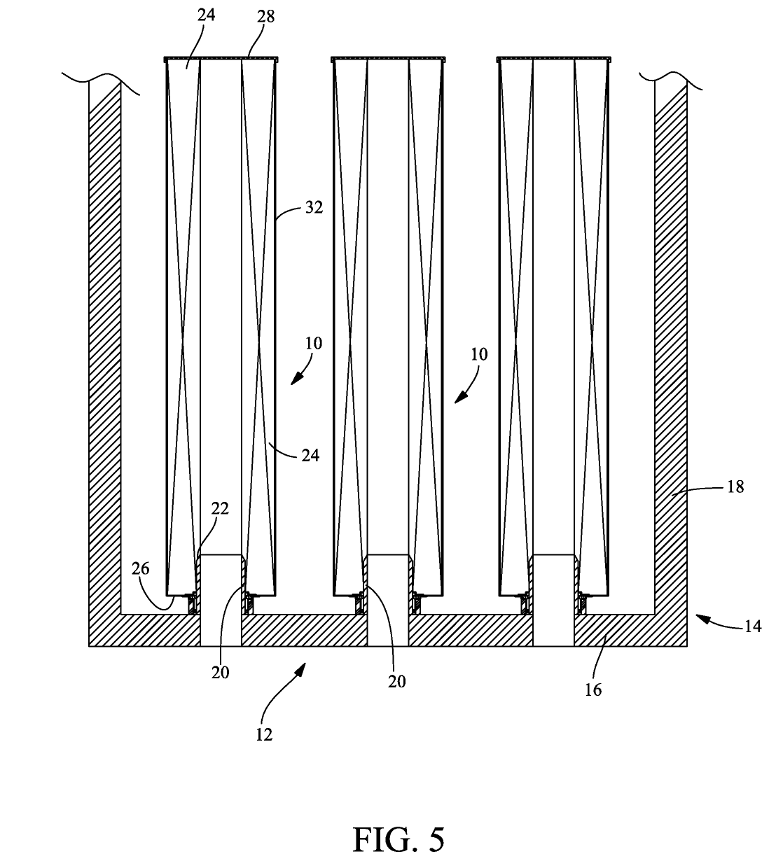

Turning to FIGS. 3-5, an embodiment of the present invention has been shown as a filter cartridge 10. The filter cartridge 10 may be employed in a filter assembly 12 as shown in FIG. 5 that includes, in combination, a bank of filter cartridges 10 which are installed on and into a housing such as may be used for oil lube filtration or other appropriate filtration. The embodiment shown may be used in an application for an oil lube filtration in large large medium speed diesel engine applications in which the axial length of the overall housing is at least two feet long so as to accommodate relatively long filter cartridges 10 that also extend at least two feet in length and typically at least six inches in diameter.

The housing 14 includes a flat mounting face 16 in an outer annular wall 18 projecting axially from the front mounting face 16 so as to surround and enclose the filter cartridges 10. A plurality of stem pipes 20 project axially from the flat mounting face 16 in spaced relation such that each stem pipe 20 is adapted to receive a filter cartridge 10 with a fluidically sealed connection therebetween. Each stem pipe 20 preferably has a tapered end 22 that helps center and locate the filter cartridges 10 as they are installed on the stem pipes 20. As will readily be appreciated in applications where the filter cartridges 10 are long, such as exceeding two feet in length, and diameters exceeding six inches that manual removal and installation of such filter cartridges 10 is done substantially blind in that it may be difficult or hard to see how the filter cartridge 10 is being installed on the stem pipes 20. The present embodiment appreciates these particular difficulties are present and provides for a more reliable and redundant sealing system in case a more reliable sealing device fails due to the substantially blind filter cartridge mounting.

Turning to the improved filter cartridge 10, it includes a tubular ring of pleated filter media 24 that extends axially between an open end cap 26 and a closed end cap 28. Each of the end caps 26, 28 is sealingly bonded to opposed axial ends of the pleated filter media 24 preferably with appropriate adhesive such as plastisol or other bonding or potting agent. While plastic or other material end caps might be used, preferably the end caps 26, 28 are formed from stamped metal. Each end cap 26, 28 is cup shaped so as to define a well region 30 into which suitable sealing adhesive may be received and temporarily retained to facilitate assembly and caring of the adhesive. Preferably, a perforated paper or metal wrapper 32 cylindrically surrounds the outer periphery of the filter cartridge and extends between opposed end caps 26, 28. An embodiment may also employ a center tube (not shown) extending axially between end caps 26, 28 along the inside of the ring of pleated filter media 24.

The open end cap has a central opening 34 that provides a fluid port that facilitates communication through the stem pipe 20 when mounted thereto. As shown therein and in accordance with certain aspects of the present invention, two different radial seals are provided bounding this central opening 34 including a flat gasket 36 and an O-ring gasket 38. The flat gasket 36 can seal through slight deflection when engaged against the pipe stem 20, working as a wiper seal, whereas the O-ring gasket 38 seals in a slight different manner through a slightly radial compression. Both of these gaskets are formed with suitable elastomeric sealing material. In the mounted state, both of these gaskets 36, 38 engage and seal against one of the stem pipes 20 as shown in FIG. 5.

Additionally, the filter cartridge 10 may also preferably include a face seal gasket 40 that is in surrounding relation but axially offset of the O-ring gasket 38 and flat gasket 40. Each of the gaskets provide a means for sealing and are annular in shape to facilitate the same. In the case of the flat gasket 36 and the O-ring gasket 38, the sealing is accomplished with a radial seal whereas with the face seal gasket 40, an axial abutment seal is formed by virtue of an annular projecting free end 42 and flat annular face 44 that abuts against the flat mounting face 16 of the housing 14.

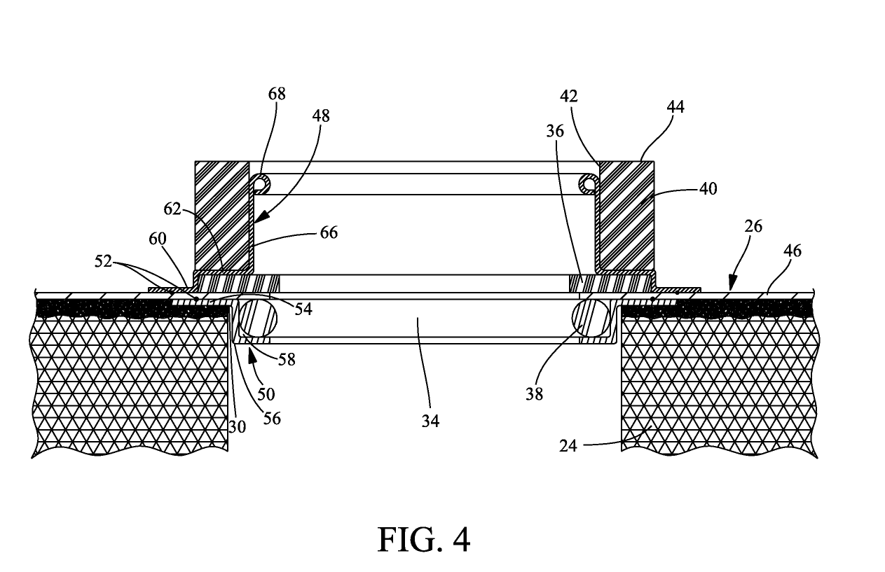

Referring to FIG. 4, each of these gaskets 36, 38, 40 can all be carried commonly by the same open end cap 26. In this embodiment, the open end cap includes a metal end disc member 46, a metal outer retainer 48 and a metal inner retainer 50. The disc member 46 is sealingly bonded directly to the end of the filter media 24 and/or welded to each of the outer and inner retainers via spot welds 52 illustrated at different locations and typically intermittent locations in an annular array about the axis.

The inner retainer 50 retains the O-ring gasket 38 inside of the metal disc member 46. To facilitate the same, the retainer includes a weld flange 54 connected via spot welds 52 to the disc member 46 in an inner projecting step 56 depending therefrom that defines an inner annular groove 58 into which the O-ring gasket 38 is received and trapped.

The outer retainer 48 similarly includes an annular weld flange 60, however, weld flange 60 contains an outward projecting step 62 depending therefrom that defines an outer annular groove 64 in conjunction with the outer surface of the disc member 46 that receives and traps the annular flat gasket 36.

The outer retainer 48 also includes an annular retaining wall 66 that is generally cylindrical in shape that projects axially outward from the outward projecting step 62 to a terminating end that may take the form of a safety curl 68. The face seal gasket 40 can be fitted onto the annular retaining wall 66 in bounding relation thereof and seated axially against the outer surface of the outward projecting step 62. In this manner, the face seal gasket is supported by the annular retaining wall 66 but also is longer then the retaining wall 66 so as to provide for the axially extending free end 42 that extends beyond the retaining wall to provide a free, flat annular face 44 that can be compressed against the flat mounting face 16 of the lube filter housing 14.

The different flat gasket and O-ring gasket 36, 38 are of different sealing qualities and functions in that one is more reliable then the other when used properly while the other is less prone to damage and/or otherwise acts as a redundant backup in the event of improper installation or difficulties due to the blind mounting. The flat gasket 36 is adapted to seal as a wiper seal by a slight deflection whereas the O-ring gasket is adapted to seal by radial compression, but in either event each of these gaskets act as radial seals upon the stem pipe 20 when mounted thereto. The O-ring gasket may define a larger inner diameter then that of the flat gasket with a difference in diameters of between 0.01 and 0.05 inches.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing”are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A filter cartridge, comprising:
a tubular ring of filter media having opposed first and second ends;
a first end cap sealingly bonded to the first end;
a second end cap sealingly bonded to the second end, the second end cap including a central opening providing a fluid port communicating internally with the tubular ring of filter media;
a first gasket bounding the central opening for sealing the fluid port; and
a second gasket bounding the central opening for sealing the fluid port.

2. The filter cartridge of claim 1, wherein the first and second gaskets are carried by the second end cap, further comprising a third gasket carried by the second end cap, the third gasket in surrounding relation of the first and second gaskets.

3. The filter cartridge of claim 2, wherein the filter cartridge is intended for sealing against a flat mounting face having a stem pipe projecting from the flat mounting face, wherein the third gasket is a face seal gasket having an axial seal face adapted for axially sealing against the flat mounting face, and wherein the first and second gaskets each having a radial seal face adapted for radially sealing against the stem pipe.

4. The filter cartridge of claim 3, wherein the first gasket is an O-ring gasket, and wherein the second gasket is a flat gasket.

5. The filter cartridge of claim 4, wherein the O-ring gasket defines a larger inner diameter than the flat gasket with a difference in inner diameters of between 0.01 and 0.05 inches, wherein the flat gasket is adapted to seal as a wiper seal by slight deflection and wherein the O-ring is adapted to seal by radial compression.

6. The filter cartridge of claim 5, wherein the flat gasket acts as a redundant backup to the O-ring gasket in the event of damage to the O-ring gasket.

7. The filter cartridge of claim 1, wherein the second end cap includes a metal end disc member, a metal outer retainer and a metal inner retainer, the inner retainer retaining the first gasket inside of the metal end disc member, the metal outer retainer retaining the second gasket outside of the metal end disc member.

8. The filter cartridge of claim 7, wherein the inner retainer includes a weld flange welded to an inner surface of the metal end disc member and an inward projecting step defining an inner annular groove in conjunction with the inner surface, the inner annular groove trapping the first gasket, and wherein the outer retainer includes a weld flange welded to an outer surface of the metal end disc member and an outward projecting step defining an outer annular groove in conjunction with the outer surface, the outer annular groove trapping the second gasket.

9. The filter cartridge of claim 8, wherein the first gasket is an O-ring gasket and wherein the second gasket is a flat gasket.

10. The filter cartridge of claim 9, further comprising an annular retaining wall projecting axially outward from the outward projecting step, and further comprising a face seal gasket bounding the annular retaining wall and seated axially against the outward projecting step, the face seal gasket having a free terminating end projecting axially from a terminating end of the annular retaining wall to define a flat annular axial seal abutment.

11. The filter cartridge of claim 10, wherein the O-ring gasket defines a larger inner diameter than the flat gasket with a difference in inner diameters of between 0.01 and 0.05 inches, wherein the flat gasket is adapted to seal as a wiper seal by slight deflection and wherein the O-ring is adapted to seal by radial compression.

12. The filter cartridge of claim 10, wherein the terminating end of the annular retaining wall is a curl.

13. A filter cartridge for sealing against a flat mounting face having a stem pipe projecting from the flat mounting face, comprising:
a tubular ring of filter media;
end caps on either end of the filter media;
first means for sealing against the stem pipe; and
second means for sealing against the stem pipe in redundancy to the first means.

14. The filter cartridge of claim 13, further comprising:
third means for axially sealing against the flat mounting face.

15. The filter cartridge of claim 14, wherein the first, second and third means are commonly carried by one of the end caps.

16. The filter cartridge of claim 15, further comprising:
means for retaining the first means to said one of the end caps; and
means for retaining the second means and third means to said one of the end caps.

17. The filter cartridge of claim 15, wherein the filter cartridge has a length of greater than about two feet and a diameter of at least about six inches, wherein the dimensions afford a substantially blind mounting onto the stem pipe, and wherein the first means comprises an O-ring gasket and the second means comprises a flat gasket, the flat gasket and the O-ring gasket each defining an inner diameter with a difference of less than 0.05 inches in diameter, and wherein the flat gasket serves to seal against the stem pipe in the event the O-ring gasket is damaged due to error of said substantially blind mounting.

18. A filter assembly, comprising in combination:
a housing having a flat mounting face and outer wall projecting axially away therefrom greater than two feet, a plurality of stem pipes projecting from the flat mounting face in spaced apart relation, each stem pipe having a tapered end tip;
a plurality of filter cartridges, one filter cartridge mounted on each stem pipe, each filter cartridge including:
a tubular ring of filter media having opposed first and second ends;
a first end cap sealingly bonded to the first end; and
a second end cap sealingly bonded to the second end, the second end cap including a central opening providing a fluid port communicating internally with the tubular ring of filter media;
an O-ring gasket carried by the second end cap, bounding the central opening and radially sealing against one of the stem pipes;
a flat gasket carried by the second end cap, bounding the central opening and radially sealing against one of the stem pipes; and
a face seal gasket carried by the second end cap in surrounding relation of the O-ring gasket and flat gasket, the face seal gasket projecting axially from the second end cap and sealing axially against the mounting face.

19. The filter assembly of claim 18, wherein the second end cap includes a metal end disc member, a metal outer retainer and a metal inner retainer, the inner retainer retaining the O-ring gasket inside of the metal end disc member, the metal outer retainer retaining the flat gasket outside of the metal end disc member, wherein the inner retainer includes a weld flange spot welded to an inner surface of the metal end disc member and a projecting step defining an inner annular groove in conjunction with the inner surface, the inner annular groove trapping the O-ring gasket, and wherein the outer retainer includes a weld flange spot welded to an outer surface of the metal end disc member and an outward projecting step defining an outer annular groove in conjunction with the outer surface, the outer annular groove trapping the flat gasket.

20. The filter assembly of claim 19, further comprising an annular retaining wall projecting axially outward from the outward projecting step to a terminating end in the form of a curl, wherein the face seal gasket bounds the annular retaining wall and seated axially against the outward projecting step, the face seal gasket having a free terminating end projecting axially from a terminating end of the annular retaining wall to define a flat annular axial seal abutment, wherein the O-ring gasket defines a larger inner diameter than the flat gasket with a difference in inner diameters of between 0.01 and 0.05 inches, wherein the flat gasket is adapted to seal as a wiper seal by deflection and wherein the O-ring is adapted to seal by radial compression, and wherein each filter cartridge has an axial length of greater than about two feet and a diameter of at least about six inches.
